(19) United States
(12) Patent Application Publication
(10) Pub. No.: US 2017/0197867 A1
(43) Pub. Date: Jul. 13, 2017

(54) HERMETIC SEALING METHOD AND HERMETIC-SEALED SUBSTRATE PACKAGE

(71) Applicant: Corning Precision Materials Co., Ltd., Chungcheongnam-do (KR)

(72) Inventors: Choon Bong Yang, Chungcheongnam-do (KR); Ki Yeon Lee, Chungcheongnam-do (KR); Bo Mi Kim, Chungcheongnam-do (KR); Jhee Mann Kim, Chungcheongnam-do (KR); Yoon Seuk Oh, Chungcheongnam-do (KR)

(73) Assignee: Corning Precision Materials Co., Ltd., Chungcheongnam-do (KR)

(21) Appl. No.: 15/326,340

(22) PCT Filed: May 11, 2015
(86) PCT No.: PCT/KR2015/004664

§ 371 Date: Jan. 13, 2017

(30) Foreign Application Priority Data
Jul. 14, 2014 (KR) 10-2014-0088490

(51) Int. Cl. C03B 23/24

(52) U.S. Cl. CPC C03B 23/24

(57) ABSTRACT

The present invention relates to a hermetic sealing method and a hermetic-sealed substrate package and, more specifically, to a hermetic sealing method for hermetically sealing the space between two substrates by a glass frit paste, and a substrate package manufactured thereby. To this end, the present invention provides a hermetic sealing method comprising: a substrate preparation step for preparing a first substrate and a second substrate smaller than the first substrate; a glass frit paste applying step for applying the glass frit paste such that the glass frit paste adheres to the upper periphery of the first substrate and a side of the second substrate while the first and second substrates are disposed to face each other; and a laser irradiation step for irradiating a laser beam to the applied glass frit paste to hermetically seal the space between the first and second substrates.

### TECHNICAL FIELD

The present disclosure relates to a hermetic sealing method and a hermetically sealed substrate package. More particularly, the present disclosure relates to a hermetic sealing method for hermetically sealing a space between two substrates using a glass frit paste and a substrate package fabricated therewith.

### BACKGROUND ART

Devices sensitive to aspects of the external environment, such as moisture and oxygen, are commonly hermetically sealed for protection from the external environment. In particular, organic light-emitting diodes (OLEDs) that have been regarded as next generation display devices due to possessing many inherent advantages, such as a wide viewing angle, superior contrast, and rapid response speeds, are hermetically sealed to prevent electrodes and organic layers from being deteriorated by moisture and oxygen.

In addition, a pair of glass panes used for windows and doors of buildings due to superior heat insulation are hermetically sealed to retain a vacuum therebetween.

Hermetic sealing as described above is typically carried out by applying a paste to a peripheral portion of at least one of two substrates and bonding the two substrates to each other.

Korean Patent Application Publication No. 10-2012-0041438 discloses a method of forming frit into the shape of a bar, disposing the bar-shaped frit between a first glass pane and a second glass pane, and hermetically sealing the first and second glass panes using a heat treatment. However, this method has the following problems: A high-temperature vacuum chamber is required. In addition, when clamps are used to fix the first and second glass panes, it is difficult to secure uniform bonding surfaces. Consequently, vacuum processing increases a defective rate.

Korean Patent Application Publication No. 10-2006-0005369 discloses a method of hermetically sealing a first substrate plate and a second substrate plate by softening a frit by heating the frit using a laser beam. Here, the laser beam heats and softens the frit after passing through the first substrate plate or the second substrate plate. In this case, portions of the laser beam may be refracted and absorbed by the substrate plate, thereby making it impossible to accurately supply energy to the frit. Consequently, the frit may not be sufficiently bonded to the substrate plate, which is problematic.

### DISCLOSURE

### Technical Problem

Accordingly, the present disclosure has been made in consideration of the above problems occurring in the related art, and the present disclosure proposes a hermetic sealing method for increasing the bondability of a glass frit paste to two substrates spaced apart from each other, the glass frit paste hermetically sealing a space defined by the two substrates, and a substrate package fabricated by the same method.

### Technical Solution

According to an aspect of the present disclosure, a hermetic sealing method may include: preparing a first substrate and a second substrate, smaller than the first substrate; disposing the first substrate and the second substrate to face each other and applying a glass frit paste to a peripheral portion of a top surface of the first substrate and to a side wall surface of the second substrate; and irradiating the applied glass frit paste with a laser beam, thereby hermetically sealing a space between the first substrate and the second substrate.

In the step of irradiating the glass frit paste, the laser beam may be directly provided to the glass frit paste. It is preferable that the laser beam is provided in a direction from the second substrate to the first substrate.

In addition, the glass frit paste may contain at least one selected from the group consisting of V₂O₅, carbon powder, and carbon nanotubes.

Furthermore, a spacer may be provided on at least one of the first substrate and the second substrate to maintain a predetermined distance between the first substrate and the second substrate.

In addition, the coefficient of thermal expansion of the glass frit paste may range from 80*10⁻⁷/° C. to 90*10⁻⁷/° C.

The laser beam may be a CO₂ laser beam.

Furthermore, the hermetic sealing method may further include applying an epoxy resin or an acrylic resin to an external surface of the glass frit paste.

According to another aspect of the present disclosure, a hermetically sealed substrate package may include: a first substrate; a second substrate, smaller than the first substrate; and a sealant bonded to a peripheral portion of a top surface of the first substrate and to a side wall surface of the second substrate to hermetically seal a space between the first substrate and the second substrate.

### Advantageous Effects

According to the present disclosure, it is possible to improve the bondability of a glass frit pate and prevent substrates from being damaged by laser beams.

### DESCRIPTION OF DRAWINGS

FIG. 1 is a schematic flowchart illustrating a hermetic sealing method according to an embodiment of the present disclosure;

FIG. 2 is a schematic cross-sectional view illustrating a hermetically sealed substrate package fabricated using the hermetic sealing method;

FIG. 3 is a graph illustrating the height of the glass frit paste which has been irradiated with a laser beam; and

FIG. 4 is a schematic perspective view illustrating a hermetically sealed substrate package according to an embodiment of the present disclosure.

### MODE FOR INVENTION

Hereinafter, a hermetic sealing method and a hermetically sealed substrate package according to embodiments of the present disclosure will be described in detail with reference to the accompanying drawings.

In the following description, detailed descriptions of known functions and components incorporated herein will be omitted in the case that the subject matter of the present disclosure is rendered unclear by the inclusion thereof.

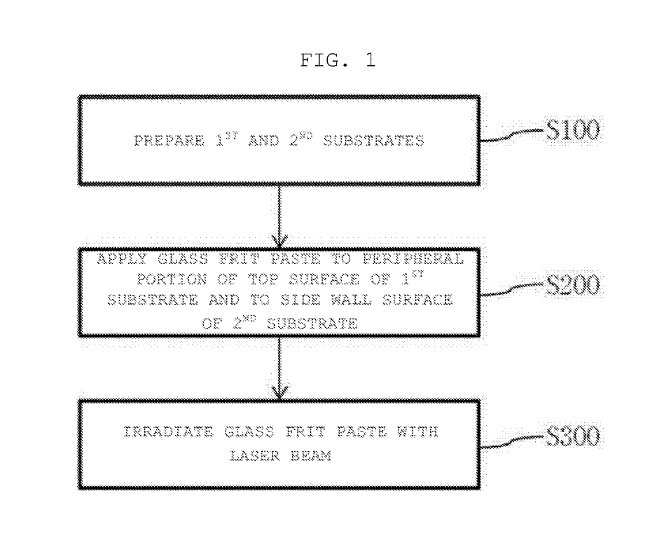

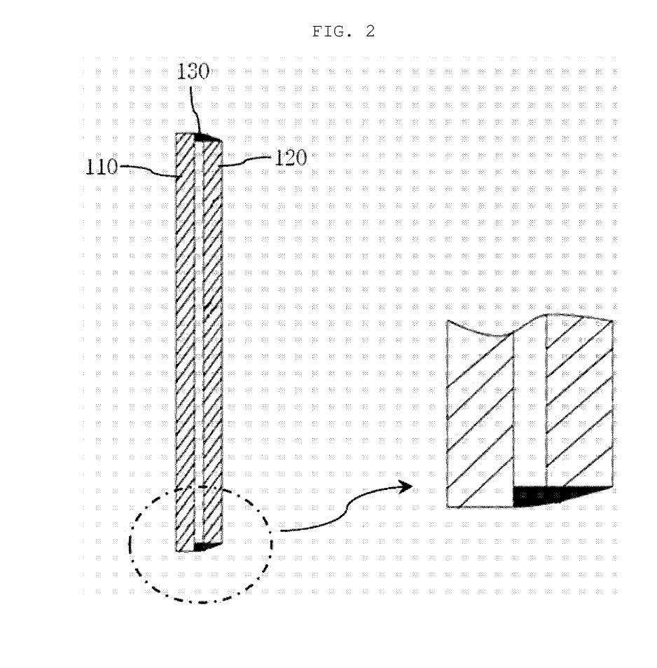

FIG. 1 is a schematic flowchart illustrating a hermetic sealing method according to an embodiment of the present disclosure, and FIG. 2 is a schematic cross-sectional view illustrating a hermetically sealed substrate package fabricated by the same hermetic sealing method.

The hermetic sealing method is a method of hermetically sealing two substrates spaced apart from each other using a glass frit paste, such that an internal space isolated from external moisture and air is defined between the two substrates. As illustrated in FIG. 1, the hermetic sealing method includes a substrate preparation step S100, a glass frit paste application step S200, and a laser irradiation step S300.

According to some embodiments of the present disclosure, a first substrate 110 and a second substrate 120 smaller than the first substrate 110 are prepared to hermetically seal a space defined between the first substrate 110 and the second substrate 120.

The first substrate 110 and the second substrate 120 are substrates to which a glass frit paste 130 is bonded to form the internal space that is hermetically sealed. Here, the size (area) of the second substrate 120 is smaller than the size (area) of the first substrate 110.

The first substrate 110 and the second substrate 120 may be glass substrates. The first substrate 110 and the second substrate 120 may be soda-lime glass substrates. The first substrate 110 and the second substrate 120 may be tempered glass substrates or chemically-toughened glass substrates. However, this is not intended to be limiting, and substrates formed from plastic may also be used.

The first substrate 110 and the second substrate 120 may have a thickness of 0.5 mm or greater or a thickness of 3 mm or greater.

A spacer may be formed on at least one of the first substrate 110 and the second substrate 120 to maintain a predetermined distance between the first substrate 110 and the second substrate 120. Since the first substrate 110 and the second substrate 120 defining a vacuum space therebetween due to hermetic sealing may come into contact with each other over time due to the difference between internal pressure and external pressure, the spacer may be formed on at least one of the first substrate 110 and the second substrate 120 to prevent this problem. The height of the spacer is equal to the distance by which the first substrate is spaced apart from the second substrate. The spacer formed on the first substrate 110 is located on the surface facing the second substrate 120, while the spacer formed on the second substrate 120 is located on the surface facing the first substrate 110. The spacer may be one or more spacers and may be formed from the same material as the first substrate 110 and the second substrate 120.

Afterwards, the first substrate 110 and the second substrate 120 are disposed to face each other and a glass frit paste 130 is applied to the peripheral portion of the top surface of the first substrate 110 and to the side wall surface of the second substrate 120 (S200).

The first substrate 110 and the second substrate 120 are disposed to face each other and to form steps. Normal lines passing through the centers of the first substrate 110 and the second substrate 120 may be collinear.

The glass frit paste 130 is applied to the first substrate 110 and the second substrate 120 such that the glass frit paste 130 is bonded to the peripheral portion of the top surface of the first substrate 110 and to the side wall surface of the second substrate 120. The glass frit paste 130 can be applied as described above, since the first substrate 110 has an area greater than that of the second substrate 120 according to an embodiment of the present disclosure. Here, the top surface is a surface of the first substrate 110 that faces the second substrate 120.

The glass frit paste 130 used in an embodiment of the present disclosure can be manufactured by mixing a low-melting point glass frit with a vehicle in which ester alcohol and ethyl cellulose binder are mixed. The manufacturing of the glass frit paste 130 as described above makes it possible to bond the glass frit paste 130 to the first substrate 110 and the second substrate 120 at room temperature without separate firing.

The glass frit paste 130 may be composed of at least one selected from among V₂O₅, carbon powder, and carbon nanotubes. These elements have superior ability to absorb laser beams, thereby improving the ability of the glass frit paste 130 to be attached to the first substrate 110 and the second substrate 120.

In addition, a dispersing agent, a stabilizing agent, a surfactant, and the like may be additionally mixed into the glass frit paste 130.

When the first substrate 110 and the second substrate 120 are glass substrates, the coefficient of thermal expansion of the glass frit paste 130 may range from 80*10⁻⁷/° C. to 90*10⁻⁷/° C., which is similar to the coefficient of thermal expansion of glass.

In addition, it may be preferable that the glass frit paste 130 has a higher ability to absorb the wavelengths of a laser beam, for example, 810 nm. Furthermore, the softening temperature of the glass frit paste 130 may be lower than or at least equal to the softening temperature of the first substrate 110 and the second substrate 120 and the glass frit paste 130 may be highly resistant to water.

The glass frit paste 130 can be applied to a thickness equal to a total of the distance between the first substrate 110 and the second substrate 120 and the thickness of the second substrate 120. In addition, the thickness to which the glass frit paste 130 is applied may be adjusted by the amount and granularity of a glass frit contained in the glass frit paste 130.

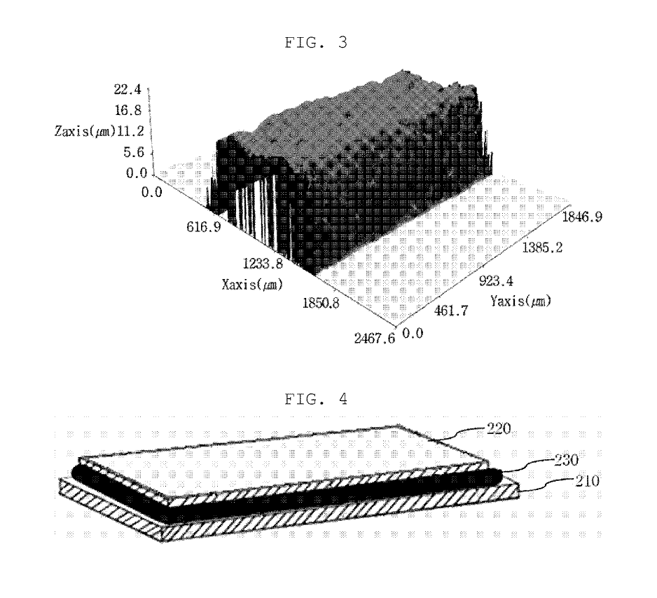

FIG. 3 is a graph illustrating the height of the glass frit paste, according to an embodiment of the present disclosure, which has been irradiated with a laser beam.

Finally, the space defined between the first substrate 110 and the second substrate 120 is hermetically sealed by irradiating the glass frit paste 130 with a laser beam (S300).

When the glass frit paste 130 is irradiated with the laser beam, the glass frit paste 130 is heated and thus softened. Through the subsequent process of cooling, the glass frit paste 130 hermetically seals the space between the first substrate 110 and the second substrate 120.

Here, the laser beam may be a CO₂ laser beam.

The laser beam may be directly provided to the glass frit paste 130.

The direct irradiation of the glass frit paste 130 with the laser beam can improve the bondability of the glass frit paste 130 and prevent the substrates from being damaged by the laser beam. Specifically, when a laser beam is provided to the glass frit paste after passing through the first substrate or the second substrate as in the background art, the entirety of the energy of the laser beam may not be supplied to the glass frit and the first substrate or the second substrate may be damaged, since portions of the laser beam may be absorbed or scattered by the first substrate or the second substrate. In contrast, the present disclosure prevents such problems by directly irradiating the glass frit paste.

The laser beam may be provided in the direction from the second substrate 120 to the first substrate 110.

This type of laser irradiation is enabled since the size of the second substrate 120 is smaller than the size of the first substrate 110 and the glass frit paste 130 is applied and bonded to the side wall surface of the second substrate 120. Since the laser beam is provided in the direction from the second substrate 120 to the first substrate 110, i.e. the laser is provided in the direction from the second substrate 120 to the first substrate 110 to be perpendicular to the principal planes of the first substrate 110 and the second substrate 120, it is possible to prevent functional layers, such as organic layers, that may be formed in the hermetically sealed internal space from being damaged by the laser beam.

The hermetic sealing method according to an embodiment of the present disclosure may further include a step of applying an epoxy or acrylic resin to the external surface of the glass frit paste after the laser irradiation step S300.

The application of the epoxy or acrylic resin to the external surface of the glass frit paste as described above can improve the reliability of the hermetic sealing.

Although the hermetic sealing according to the present disclosure may be carried out in a vacuum chamber, the present disclosure is not limited thereto. When the hermetic sealing is not carried out in the vacuum chamber, the internal vacuum space may be formed by bonding a first substrate and a second substrate, one of which has a hole, using a glass frit paste, evacuating air through the hole, and closing the hole.

FIG. 4 is a schematic perspective view illustrating a hermetically sealed substrate package according to an embodiment of the present disclosure.

As illustrated in FIG. 4, the hermetically sealed substrate package according to the present disclosure includes a first substrate 210, a second substrate 220, and a sealant 230.

Descriptions of the first substrate 210 and the second substrate 220 will be omitted, since the first substrate 210 and the second substrate 220 are the same as the first substrate 110 and the second substrate 120 that have been described above.

The sealant 230 is bonded to the peripheral portion of the top surface of the first substrate 210 and to the side wall surface of the second substrate 220 to hermetically seal the space between the first substrate 210 and the second substrate 220.

The sealant 230 can be formed by laser-irradiating the glass frit paste applied and bonded to the peripheral portion of the top surface of the first substrate 210 and to the side wall surface of the second substrate 220 as described above.

The foregoing descriptions of specific exemplary embodiments of the present disclosure have been presented with respect to the drawings. They are not intended to be exhaustive or to limit the present disclosure to the precise forms disclosed, and obviously many modifications and variations are possible for a person having ordinary skill in the art in light of the above teachings.

It is intended therefore that the scope of the present disclosure not be limited to the foregoing embodiments, but be defined by the Claims appended hereto and their equivalents.

### DESCRIPTION OF REFERENCE NUMERALS IN DRAWINGS

110, 210: FIRST SUBSTRATE

120, 220: SECOND SUBSTRATE

130: GLASS FRIT PASTE

140: SEALANT

1. A hermetic sealing method comprising:
preparing a first substrate and a second substrate, smaller than the first substrate;
disposing the first substrate and the second substrate to face each other and applying a glass frit paste to a peripheral portion of a top surface of the first substrate and to a side wall surface of the second substrate; and
irradiating the applied glass frit paste with a laser beam, thereby hermetically sealing a space between the first substrate and the second substrate.

2. The hermetic sealing method of claim 1, wherein, in the step of irradiating the glass frit paste, the laser beam is directly provided to the glass frit paste.

3. The hermetic sealing method of claim 2, wherein the laser beam is provided in a direction from the second substrate to the first substrate.

4. The hermetic sealing method of claim 1, wherein the glass frit paste contains at least one selected from the group consisting of V₂O₅, carbon powder, and carbon nanotubes.

5. The hermetic sealing method of claim 1, further comprising applying an epoxy resin or an acrylic resin to an external surface of the glass frit paste.

6. The hermetic sealing method of claim 1, wherein a spacer is provided on at least one of the first substrate and the second substrate to maintain a predetermined distance between the first substrate and the second substrate.

7. The hermetic sealing method of claim 1, wherein a coefficient of thermal expansion of the glass frit paste ranges from 80*10⁻⁷/° C. to 90*10⁻⁷/° C.

8. The hermetic sealing method of claim 1, wherein the laser beam comprises a CO₂ laser beam.

9. A hermetically sealed substrate package, comprising:
a first substrate;
a second substrate, smaller than the first substrate; and
a sealant bonded to a peripheral portion of a top surface of the first substrate and to a side wall surface of the second substrate to hermetically seal a space between the first substrate and the second substrate.
